(19) United States
(12) Patent Application Publication
(10) Pub. No.: US 2011/0151972 A1
(43) Pub. Date: Jun. 23, 2011

(54) METHODS FOR PROVIDING CONTENT TO A GAMING ACCOUNT AND APPARATUSES THEREOF

(75) Inventors: Gregg R. Olin, Fariport, NY (US); Joshua T. Olin, Santa Monica, CA (US)

(73) Assignee: MIND OPTICS LLC, Fairport, NY (US)

(21) Appl. No.: 12/958,053

(22) Filed: Dec. 1, 2010

Related U.S. Application Data
(60) Provisional application No. 61/265,499, filed on Dec. 1, 2009.

(51) Int. Cl. A63F 13/00

(52) U.S. Cl. 463/31

(57) ABSTRACT

A method, non-transitory computer readable medium, and an apparatus that provides an interactive pop-up with an offer to download content for display during programming on a television associated with a gaming computing device. A determination is made whether an action with regard to the interactive pop-up was received indicating a selection of the offer. The content is downloaded to an online gaming account for the gaming computing device associated with the television which was on and displayed the interactive pop-up when the action indicating the selection was received.

This application claims the benefit of U.S. Provisional Patent Application Serial No. 61/265,499, filed Dec. 1, 2009, which is hereby incorporated by reference in its entirety.

### FIELD

This invention relates to methods for providing content to a gaming account based on interaction with a television and apparatuses thereof.

### BACKGROUND

While the concept of an online conference has been around for some time now, these online conferences are focused on traditional, business to business, industry trade shows and conferences, such as real estate, pharmaceuticals, technology, and the like. These online conferences are geared to address five primary objectives: 1) reduce attendee costs (hotel, airfare); 2) increase attendees by having more flexible, on-demand content; 3) distribute keynote and product literature; 4) demonstrate latest innovations or products; and 5) provide for business networking.

Unfortunately, these existing online conventions have a number of limitations. For example, most of these existing online conventions are designed and implemented to at best support thousands or tens of thousands of attendees, but with no ability to scale up to or encourage and support millions of potential attendees. Additionally, accessibility to these existing online conferences has been limited to access through a personal computer using either a browser or proprietary client-side software which must be downloaded by each participant for each online convention. Further, access to and interaction with the online convention for both booth and other convention set up as well as for convention participants has been difficult and limited.

### SUMMARY

A method for providing an online event includes providing with an online event host computing device an online event space configured to interact with a gaming engine in one or more gaming computing devices. The online event host computing device obtains at least one action in the online event space from a gaming element from the gaming engine in one of the one or more gaming computing devices. The online event host computing device executes the obtained action in the online event space and provides a response to the executed action in a virtual display of the online event space to the one of the one or more gaming computing devices that provided the action.

A non-transitory computer readable medium having stored thereon instructions for providing an online event comprising machine executable code which when executed by at least one processor, causes the processor to perform steps including providing an online event space configured to interact with a gaming engine in one or more gaming computing devices. At least one action in the online event space is obtained from a gaming element from the gaming engine in one of the one or more gaming computing devices. The obtained action in the online event space is executed and a response to the executed action is provided in a virtual display of the online event space to the one of the one or more gaming computing devices that provided the action.

An online event host computing apparatus includes one or more processors and a memory coupled to the one or more processors. The one or more processors are configured to execute programmed instructions stored in the memory including providing an online event space configured to interact with a gaming engine in one or more gaming computing devices. At least one action in the online event space is obtained from a gaming element from the gaming engine in one of the one or more gaming computing devices. The obtained action in the online event space is executed and a response to the executed action is provided in a virtual display of the online event space to the one of the one or more gaming computing devices that provided the action.

A method for providing content to a gaming account includes providing with a gaming management computing apparatus an interactive pop-up with an offer to download content for display during programming on a television associated with a gaming computing device. The gaming management computing apparatus determines whether an action with regard to the interactive pop-up was received indicating a selection of the offer. The gaming management computing apparatus downloads the content to at least one of an online gaming account associated with the gaming computing device and the gaming computing device when the action indicating the selection was received.

A computer readable medium having stored thereon instructions method for providing content to a gaming account comprising machine executable code which when executed by at least one processor, causes the processor to perform steps comprising providing an interactive pop-up with an offer to download content for display during programming on a television associated with a gaming computing device. A determination is made whether an action with regard to the interactive pop-up was received indicating a selection of the offer. The content is downloaded to at least one of an online gaming account associated with the gaming computing device and the gaming computing device when the action indicating the selection was received.

A gaming management computing apparatus includes one or more processors and a memory coupled to the one or more processors by a bus, the one or more processors executing programmed instructions stored in the memory further comprising providing an interactive pop-up with an offer to download content for display during programming on a television associated with a gaming computing device. A determination is made whether an action with regard to the interactive pop-up was received indicating a selection of the offer. The content is downloaded to at least one of an online gaming account associated with the gaming computing device and the gaming computing device when the action indicating the selection was received.

This technology provides a number of advantages including providing a more effective and easier to use online event system for participants and vendors in a gaming environment. By utilizing the highly scalable, multi- player, online gaming environment, this technology can easily be scaled up to support millions of potential attendees in an online event format. Additionally, this technology does not require proprietary client-side software to be downloaded and executed each participant for each online event or complicated and expensive booth set-ups for vendors. With this technology, vendors can easily and inexpensively rent floor space in these virtual online events for fractions of their real-world floor cost and extend their reach from an audience of tens of thousands, to tens of millions. Further, this technology can be utilized in conjunction with a live event to enable participants to control and obtain live streaming data and other content as it occurs from the live event. Even further this technology enables vendors and participants at an online event to be interact directly and in real time with vendors and participants at a corresponding live event. Accordingly, this technology can handle and coordinate both virtual and real-world presentation and interaction. As a result, this technology redefines the concept of a trade show, convention meeting or other events from one which is selective, expensive, with a huge barrier-to-entry to one which is easy to use and participate in, inexpensive, mass-market, and with very low barrier-to-entry, for both vendors and participants alike.

### BRIEF DESCRIPTION OF THE DRAWINGS

FIG. 1 is a block diagram of an exemplary gaming environment with an online event system;

FIG. 2 is a diagram of an exemplary virtual floor plan of an online event space provided by the online event host computing device;

FIG. 3 is a diagram of an exemplary booth in the online event space illustrated in FIG. 2;

FIGS. 4A-4C are flow charts of an exemplary method for selecting and populating a booth in an online event space; and

FIGS. 5A-5C are flow charts of an exemplary method for interacting with an online event space in an online game environment;

FIG. 6 is a block diagram of another exemplary gaming environment with a gaming management computing apparatus; and

FIG. 7 is a flow chart of another exemplary method for downloading content to a designated gaming account.

### DETAILED DESCRIPTION

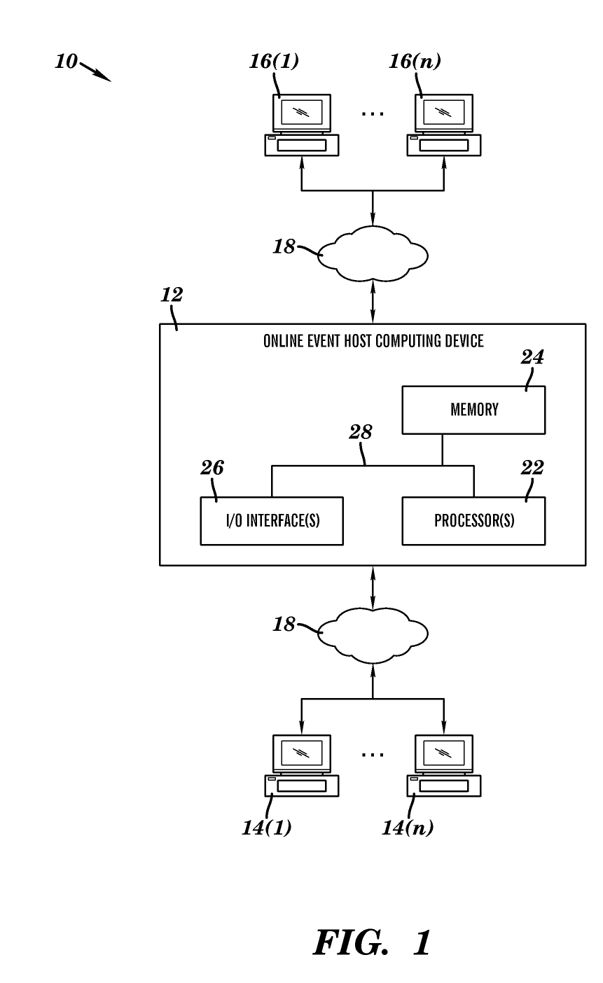

An exemplary gaming environment 10 with an online event system is illustrated in FIG. 1. This exemplary gaming environment 10 includes an online event host computing device 12, gaming computing devices 14(1)-14(n), and vendor computing devices 16(1)-16(n) which are coupled together by one or more communication networks 18, although other types and numbers of devices and components in other topologies could be used. While not shown, the environment 10 may include additional network components, such as routers, switches, and other devices. This technology provides a number of advantages including providing a more effective and easier to use online event system for participants and vendors in a gaming environment.

More specifically, the online event host computing device 12 is coupled to the gaming computing devices 14(1)-14(n) and the vendor computing devices 16(1)-16(n) through one or more networks 18, which may comprise any wide area network (e.g., Internet), although any other type of communication network topology may be used. In this example, the online event host computing device 12 manages interactions with an online event space by the gaming computing devices 14(1)-14(n) and the vendor computing devices 16(1)-16(n), although online event host computing device 12 may perform other functions and one or more interactions could be executed by other devices.

The online event host computing device 12 includes processor(s) 22, memory 24, and interface(s) 26, which are coupled together by bus 28, although each may comprise other types and numbers of elements in other configurations. The processor(s) 22 execute instructions for the set up and interaction with an online event space from gaming engines in one or more of the gaming computing devices 14(1)-14(n) as well as other operations as illustrated and described herein. The processor(s) 22 may comprise one or more central processing units (“CPUs”) or general purpose processors with one or more processing cores, such as AMD® processor(s), although other types of processor(s) could be used (e.g., Intel®).

Memory 24 may comprise one or more tangible storage media such as, for example, RAM, ROM, flash memory, CD-ROM, floppy disk, hard disk drive(s), solid state memory, DVD, or any other memory storage type or devices, including combinations thereof, which are known to those of ordinary skill in the art. Memory 24 may store one or more computer-readable instructions that may be executed by the one or more processor(s) 22. When these stored instructions are executed, they may implement processes that are illustrated, for exemplary purposes only, by the flow chart diagrams illustrated and described herein. It should be appreciated the flow chart diagrams are representative of example steps or actions that may be embodied or expressed as one or more computer or machine readable instructions or other hardware logic that may be executed or otherwise controlled by the processor(s) 22 in online event host computing device 12 shown in FIG. 1. In this example, the machine readable instructions may embody an algorithm or computer program for execution by at least one of: (a) one or more processors each having one or more processor cores, (b) hardware specifically configured to perform the instructions and (c) one or more other suitable processing device(s). The algorithm or computer program may be embodied in software stored on memory 24, for example. Input/output interfaces 26 include one or more interfaces and other physical and/or logical mechanisms for enabling online event host computing device 12 to communicate with the gaming computing devices 14(1)-14(n) and the vendor computing devices 16(1)-16(n) as well as other elements and devices.

Each of the gaming computing devices 14(1)-14(n) and each of the vendor computing devices 16(1)-16(n) include a central processing unit (CPU) or processor, a memory, and an interface or I/O system, which are coupled together by a bus or other link, although other numbers and types of network devices could be used. The gaming computing devices 14(1)-14(n), in this example each include a gaming engine to run one or more gaming applications. The game engine comprises programmed instructions that provide a platform for the use of one or video games. Since gaming engines are well known to those of ordinary skill in the art, they will not be described in greater detail here. By way of example only, gaming computing devices with gaming engines include XBox®, Playstation®, and Wii®. These gaming engines in the gaming computing devices 14(1)-14(n) can provide one or more gaming elements, such as avatars, which can be used in the online event space to walk to virtual booths, interact with other virtual attendees and interact with objects in booths in the online event space by way of example only. Additionally by way of example only, the gaming computing devices 14(1)-14(n) can comprise personal computers with gaming engines, personal digital computing devices including computer tablets and commercial gaming computing devices as discussed above.

Although an exemplary gaming environment 10 with the online event host computing device 12, the gaming computing devices 14(1)-14(n) and the vendor computing devices 16(1)-16(n) are described and illustrated herein, other types and numbers of systems, devices, components, and elements in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any example. Accordingly, principles and advantages of distributed processing, such as redundancy and replication also can be implemented, as desired, to increase the robustness and performance of the devices and systems of the examples. The examples may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples also may be embodied as non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

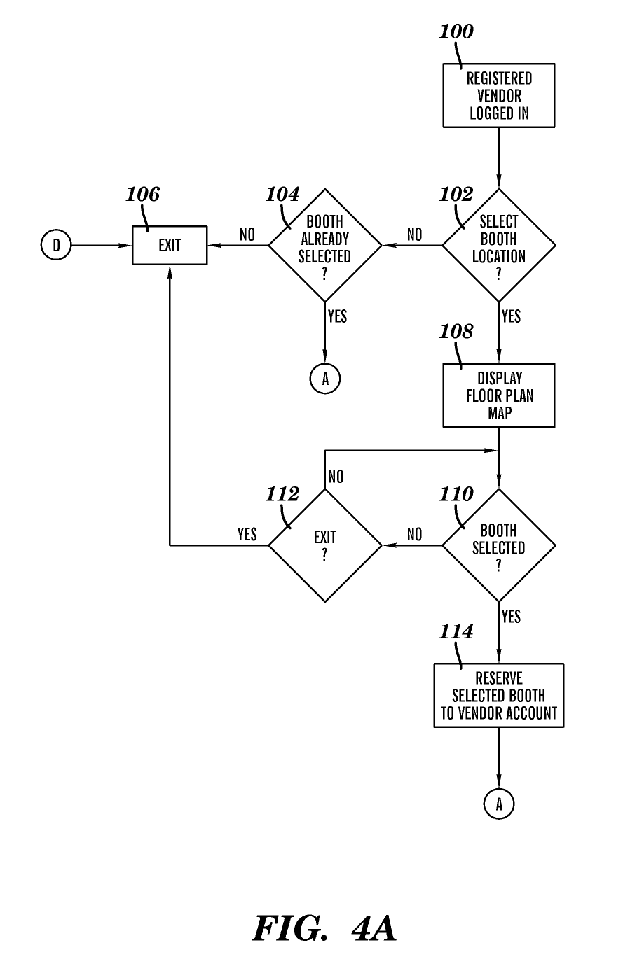

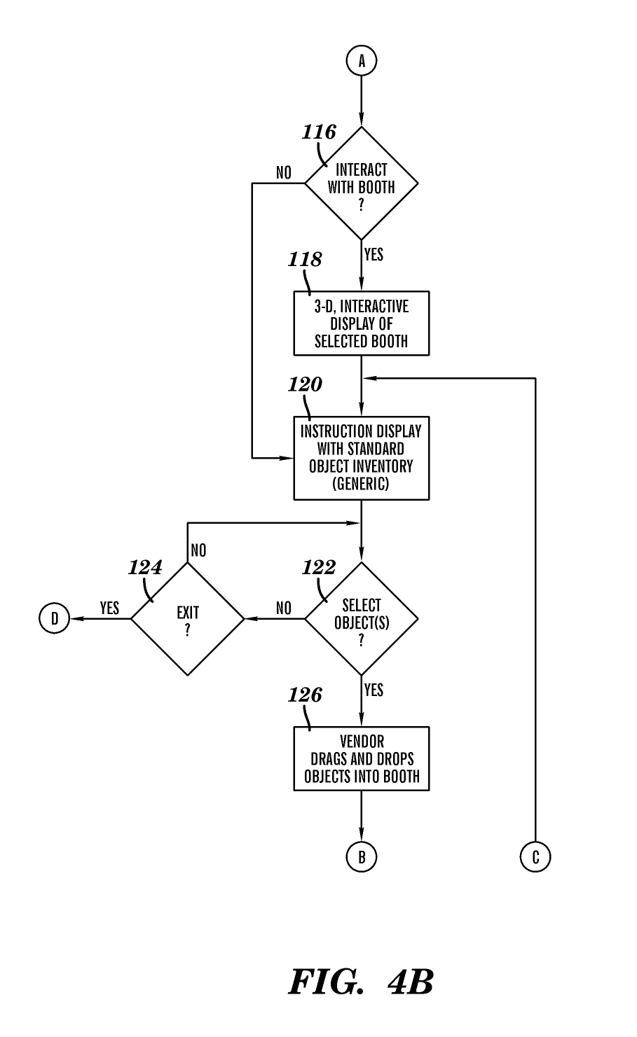

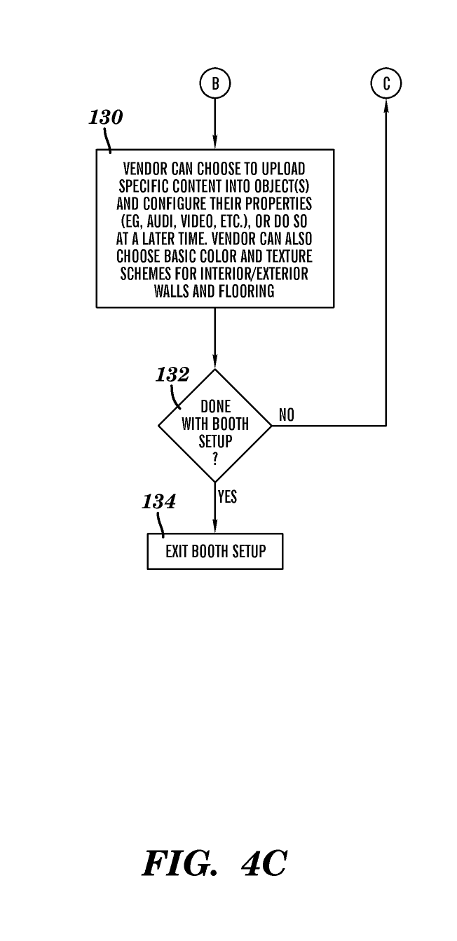

An exemplary method for selecting and populating a booth in the online event space will now be described with reference to FIGS. 1-4C, although other types of areas in the event space could be selected and configured by a vendor or other event demonstrator. Referring more specifically to FIGS. 4A-4C, in step 100 one of the vendor computing devices 16(1)-16(n) may register and then log in to select and populate one or more booths or other areas in an online event space 50 provided by the online event host computing device 12, although other manners for participating in the selection and population of one or more booths or other areas in the online event space can be used and other types of devices can participate. In this example, the online event host computing device 12 is configured to provide registration at a designated area in the event space 50 to collect information, such as name, address, e-mail, phone number from the registration one of the gaming computing devices 14(1)-14(n), although other manners for collecting registration information and other types and amounts of information can be collected. For example, billing information, such as a registered credit card, could be collected and stored at this time by the online event host computing device 12 to make any point-of-purchase interactions during the event that much easier. Additionally, the online event host computing device 12 may collect a fee at the time of registration for participating in the online event, although the fee is optional and can be collected at other times and in other manners.

In step 102, the online event host computing device 12 provides the registered one of the vendor computing devices 16(1)-16(n) with a selection of one or more available booths from the booths 54(1)-54(15) in the online event space 50 in this example, although the online event space 50 can have other types and numbers of booths or other areas which could be offered for selection and setup.

In step 102, the online event host computing device 12 determines whether the registered one of the vendor computing devices 16(1)-16(n) would like to select one or more of the booths 54(1)-54(15) in the online event space 50 which are available. If in step 102, the online event host computing device 12 determines the registered one of the vendor computing devices 16(1)-16(n) would not like to select one or more of the booths 54(1)-54(15) which are available, then the No branch is taken to step 104.

In step 104, the online event host computing device 12 determines whether the registered one of the vendor computing devices 16(1)-16(n) already has obtained one or more of the booths 54(1)-54(15) in the online event space 50. If in step 104 the online event host computing device 12 determines the registered one of the vendor computing devices 16(1)-16(n) has not already obtained one or more of the booths 54(1)-54(15), then the No branch is taken to step 106 where this method ends. If in step 104 the online event host computing device 12 determines the registered one of the vendor computing devices 16(1)-16(n) has already obtained one or more of the booths 54(1)-54(15), then the Yes branch is taken to step 116 where the obtained booth can be populated and/or modified as described later herein.

If back in step 102, the online event host computing device 12 determines the registered one of the vendor computing devices 16(1)-16(n) would like to select one or more of the booths 54(1)-54(15) which are available, then the

Yes branch is taken to step 108. In step 108, the online event host computing device 12 provides the registered one of the vendor computing devices 16(1)-16(n) an interactive map of the online event space 50 with the booths 54(1)-54(15) in this example which are still available highlighted, such as with a particular color, although other manners for designating which booths are taken and which are available can be used.

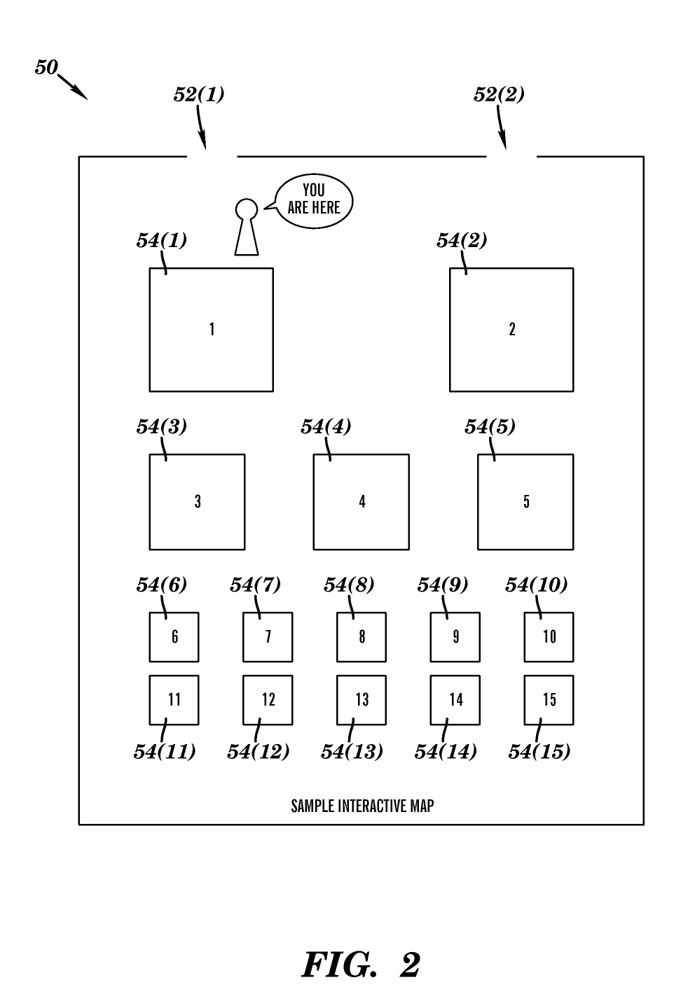

An exemplary virtual floor plan of an online event space provided by the online event host computing device 12 for display on one or more of the gaming computing devices 14(1)-14(n) is illustrated in FIG. 2. The exemplary online event space 12 has two entry/exit passages 52(1)-52(2), although the online event space could have other numbers and types of entry/exits passages or other manners of entering and leaving the online event space. Additionally, the exemplary online event space 50 has fifteen booths 54(1)-54(n) of different sizes and shapes, although the online event space could have other numbers and types of booths or other areas in the event space with other sizes and shapes and in other configurations. The hallways, billboards, and recreational portions of the online event space 50 may also be configured with various relevant advertisements, game trailers, and announcements and also can be configured to appear substantially the same as a corresponding live event that is occurring. The online event host computing device 12 may also provide an index of on or separate from the event space map shown in FIG. 2 which identifies the locations of all the other vendors currently showcasing at the online event.

In step 110, the online event host computing device 12 determines whether one of the available booths has been selected by the registered one of the vendor computing devices 16(1)-16(n). If in step 110, the online event host computing device 12 determines one or more of the available booths have not been selected by the registered one of the vendor computing devices 16(1)-16(n) then the No branch is taken to step 112.

In step 112, the online event host computing device 12 determines whether the registered one of the vendor computing devices 16(1)-16(n) would like to exit. If in step 112, the online event host computing device 12 determines the registered one of the vendor computing devices 16(1)-16(n) would like to exit, then the Yes branch is taken to step 106 where this method ends. If in step 112, the online event host computing device 12 determines the registered one of the vendor computing devices 16(1)-16(n) would not like to exit, then the No branch is taken back to step 110 to wait for a selection of one or more of the booths 54(1)-54(15) which are available.

If back in step 110, the online event host computing device 12 determines one or more of the available booths has been selected by the registered one of the vendor computing devices 16(1)-16(n) then the Yes branch is taken to step 114. In step 114, the online event host computing device 12 reserves the one or more booths 54(1)-54(15) selected from those which were available for the registered one of the vendor computing devices 16(1)-16(n).

In step 116, the online event host computing device 12 determines whether the registered one of the vendor computing devices 16(1)-16(n) would like to interact with the selected one or more booths 54(1)-54(15). If in step 116, the online event host computing device 12 determines the registered one of the vendor computing devices 16(1)-16(n) would not like to currently interact with the selected one or more booths 54(1)-54(15), then the No branch is taken to step 120 described in greater detail below. If in step 116, the online event host computing device 12 determines the registered one of the vendor computing devices 16(1)-16(n) would like to interact with the selected one or more booths 54(1)-54(15), then the Yes branch is taken to step 118.

In step 118, the online event host computing device 12 provides a three-dimensional interactive display of the one or more selected booths 54(1)-54(15) to the registered one of the vendor computing devices 16(1)-16(n), although other manners for displaying the selected booth or other selected area can be used.

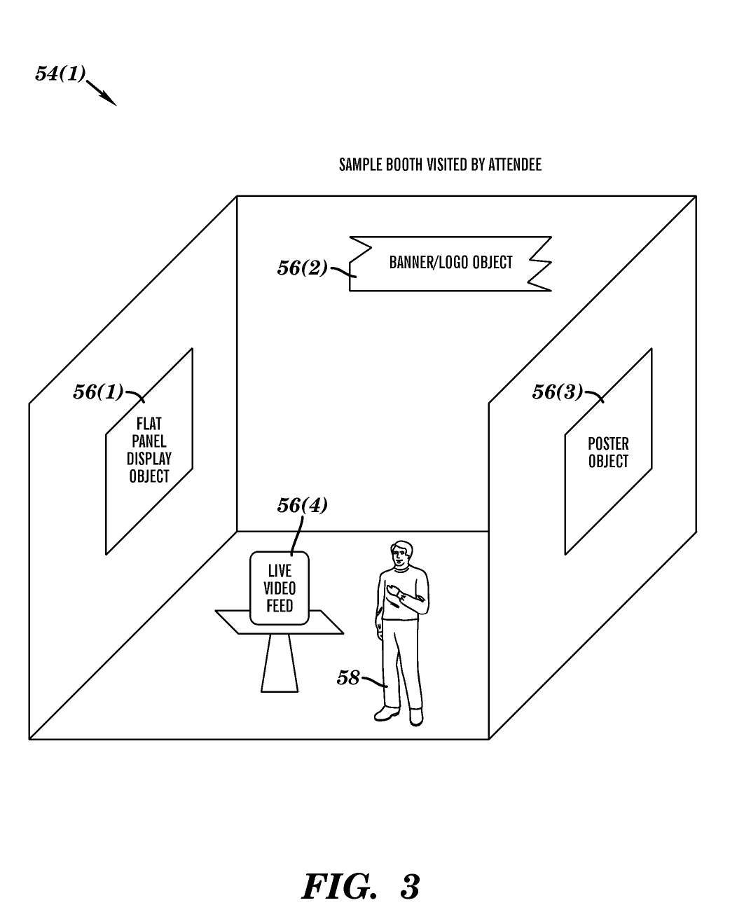

An exemplary, three-dimensional view of the selected booth 52(1) in the online event space 50 which includes different virtual objects 56(1)-56(4) is illustrated in FIG. 3, although the booth or area could have other numbers and types of objects or other elements or the booth may not yet be populated. In this example, the virtual object 56(1) is a flat panel display object, the virtual object 56(2) is a banner/logo object, the virtual object 56(3) is a poster object, and the virtual object 56(4) is a live video feed object which provide live streaming video from the on-line event, although again each booths or other area can have other numbers and types of objects and other elements in other configurations. The exemplary avatar 58 from a gaming engine for one of the gaming computing devices 14(1)-14(n) is shown as having entered the booth 52(1) and can interact with one or more of the objects 56(1)-56(4) and with other avatars or other gaming elements which may be in the booth 52(1) or elsewhere in the online event space 50.

In step 120, the online event host computing device 12 provides the registered one of the vendor computing devices 16(1)-16(n) a list of objects which can be selected, such as those illustrated in FIG. 3 by way of example only, for populating or otherwise configuring the booth or area, although other numbers and types of lists of objects or other elements could be provided and they could be provided in other manners.

In step 122, the online event host computing device 12 determines whether the registered one of the vendor computing devices 16(1)-16(n) has selected any of the objects from the provided list to populate or otherwise configure the selected booth 54(1). If in step 122 the online event host computing device 12 determines the registered one of the vendor computing devices 16(1)-16(n) has not selected any of the objects from the provided list, then the No branch is taken to step 124.

In step 124, the online event host computing device 12 determines whether the registered one of the vendor computing devices 16(1)-16(n) would like to exit. If in step 124, the online event host computing device 12 determines the registered one of the vendor computing devices 16(1)-16(n) would like to exit, then the Yes branch is taken to step 106 where this method ends. If in step 124, the online event host computing device 12 determines the registered one of the vendor computing devices 16(1)-16(n) would not like to exit, then the No branch is taken back to step 122 to wait for a selection of one or more of the objects.

If back in step 122 the online event host computing device 12 determines the registered one of the vendor computing devices 16(1)-16(n) has selected one or more of the objects from the provided list, then the Yes branch is taken to step 126. In step 126, the online event host computing device 12 stores the location of each selected object placed by the registered one of the vendor computing devices 16(1)-16(n) by dragging and dropping the selected one or more of the objects into a desired position in the selected booth 54(1), although other manners for configuring the selected one or more objects or other elements in the selected booth or other space can be used. This exemplary method for populating the booth is very easy to use and provides the registered one of the vendor computing devices 16(1)-16(n) with great control over the layout of the selected booth.

In step 130, the registered one of the vendor computing devices 16(1)-16(n) can choose to upload other types and numbers of objects or other content to populate the selected booth 54(1) which is stored by the online event host computing device 12. By way of example only, this technology allows for the customization to be almost entirely free-form, enabling the registered one of the computing devices 16(1)-16(n) to upload items, such as virtual couches, virtual posters, virtual lamps, virtual benches, virtual chairs, virtual tables, and virtual consoles, to the online event host computing device 12 for display and/or interaction with in the event space 50. In another example, if the registered one of the vendor computing devices 16(1)-16(n) wants a 6′ x 3′ billboard positioned high above their selected booth 54(1), then the online event host computing device 12 enables them to upload and physically place the billboard and position it to their liking as well as to upload custom art to lay over that billboard. In yet another example, the registered one of the vendor computing devices 16(1)-16(n) could also upload to the event space in the online event host computing device 12 a virtual object which is an arcade station which launches a demo for their game, a video player, a swag stand (to purchase apparel for their game), a pre-order station (to pre-order the game), a survey kiosk, a Twitter or live web feed, or live video and/or audio feeds, or stadium seating for attendees to sit down and prepare to listen, watch, and ask questions to a live keynote address. These exemplary virtual objects are simple to use with one click activation, although other types and numbers of interaction command options could be provided.

Additionally, the registered one of the vendor computing devices 16(1)-16(n) can configure other properties of the selected booth 54(1), such as basic color and texture schemes for interior and/or exterior walls and flooring of the selected booth, which is stored by the online event host computing device 12, although other types of properties of the selected booth can be configured in other manners. This provides the registered one of the vendor computing devices 16(1)-16(n) with even more control and ability to customize the particular content and appearance of the selected booth or other are in the event space in a very easy and user friendly manner.

In step 132, the online event host computing device 12 determines whether the registered one of the vendor computing devices 16(1)-16(n) has completed the set-up of the one or more selected booths 54(1)-54(15). If in step 132 the online event host computing device 12 determines the registered one of the vendor computing devices 16(1)-16(n) has not completed the set-up of one or more of the selected booths 54(1)-54(15), then the No branch is taken back to step 120 as described earlier. If in step 132 the online event host computing device 12 determines the registered one of the vendor computing devices 16(1)-16(n) has completed the set-up of the one or more selected booths 54(1)-54(15), then the Yes branch is taken back to step 134 where this setup method ends, although one or more additional setup steps could be executed. For example, the online event host computing device 12 could provide a simulated version of the completed booth 54(1) to the registered one of the vendor computing devices 16(1)-16(n) for a final review and approval.

An exemplary an exemplary method for interacting with an online event space in an online game environment will now be described with reference to FIGS. 1-3 and 5A-5C. Additionally, as illustrated and described in the example herein, this technology not only provides manage and coordinate activities and interactions in the online space, but also in and with a real world event occurring at the same time as the online virtual interaction. As a result, virtual participants and vendors can interact with actual participants and vendors.

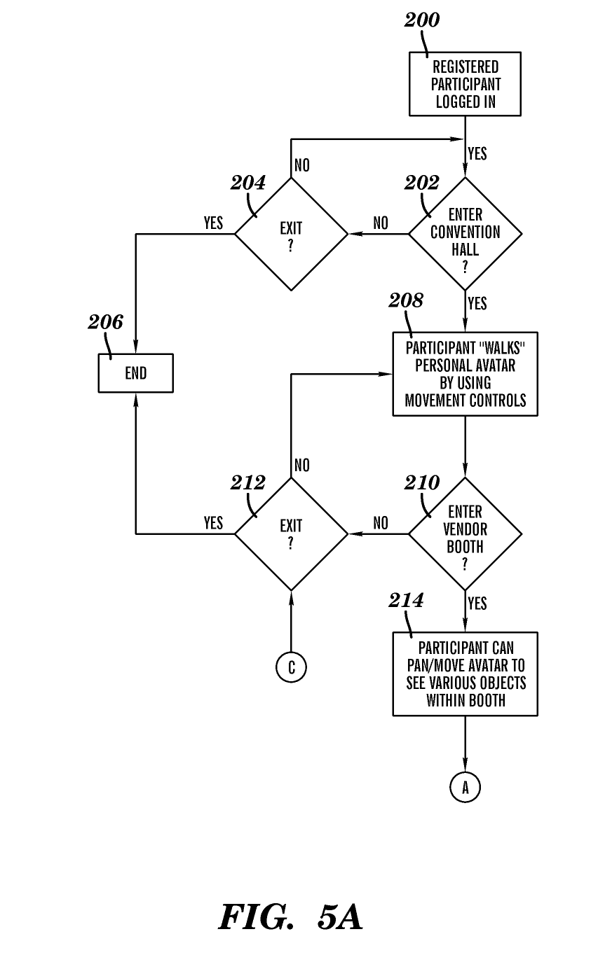

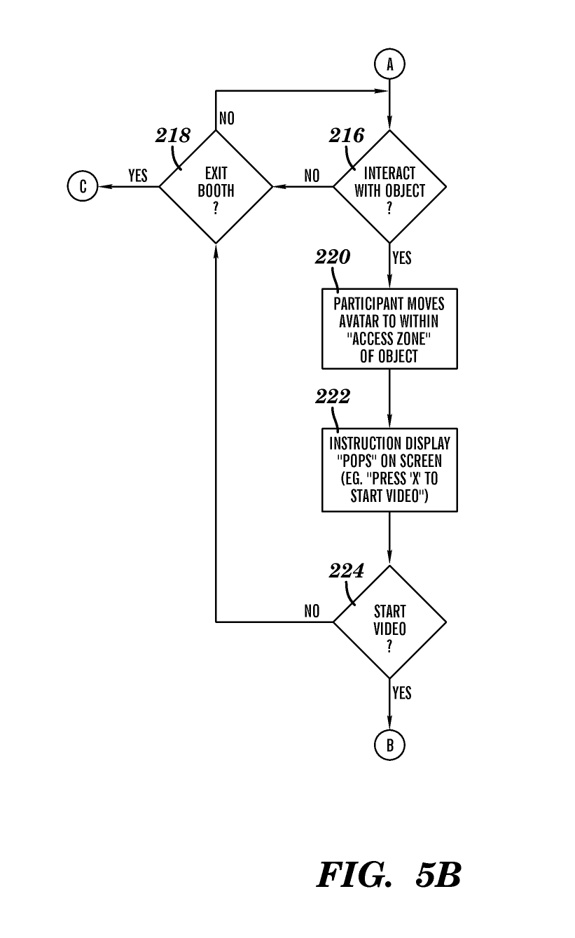

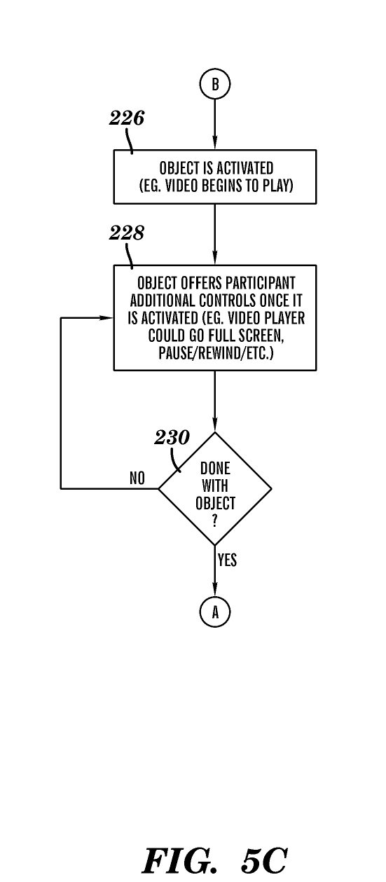

Referring more specifically to FIGS. 5A-5C, in step 200 one of the gaming computing devices 14(1)-14(n) may register and then log in to participate in an online event space 50 provided by the online event host computing device 12, although other manners for participating in the online event space can be used and other types of devices can participate. The online event space 50 may be set up and run in conjunction with a corresponding live event, such as a convention or conference by way of example only.

In step 202, the online event host computing device 12 determines whether a gaming element, such as an avatar 58, from the registered one of the gaming computing devices 14(1)-14(n) has entered the online event space 50 through one of the entry/exit passages 52(1)-52(2), although the registered one of the gaming computing devices 14(1)-14(n) could enter in other manners and with other elements and the online event space could have other numbers and types of entry/exits passages or other manners of entering and leaving the online event space. If in step 202 the online event host computing device 12 determines the gaming element from the registered one of the gaming computing devices 14(1)-14(n) has not entered the online event space 50, then the No branch is taken to step 204.

In step 204, the online event host computing device 12 determines whether the registered one of the gaming computing devices 14(1)-14(n) would like to exit. If in step 204 the online event host computing device 12 determines the registered one of the gaming computing devices 14(1)-14(n) would like to exit, then the Yes branch is taken to step 206 where this method ends. If in step 204 the online event host computing device 12 determines the registered one of the gaming computing devices 14(1)-14(n) would not like to exit, then the No branch is taken back again to step 202 described above.

In step 208, the online event host computing device 12 moves the gaming element, such as the avatar 58, around the event space 50 in response to commands from the registered one of the gaming computing devices 14(1)-14(n). The online event host computing device 12 provides a live event space map, such as the exemplary one shown in FIG. 2, to the registered one of the gaming computing devices 14(1)-14(n) which show where the avatar 58 in this example currently is located. The online event host computing device 12 may also display and allow the gaming element from the registered one of the gaming computing devices 14(1)-14(n) to see and interact with one or more other gaming elements currently in the event space 50 and may optionally view their gaming element and the online convention space 50 in two or three dimensions in real time or near real time. By utilizing gaming elements, such as the avatar 58, the different gaming computing devices 14(1)-14(n) can more easily recognize and interact with each other from their prior familiarity in other gaming environments.

In another example, the online event host computing device 12 is configured so the gaming element from the registered one of the gaming computing devices 14(1)-14(n) will be able to identify and interact with the corresponding real physical show participants that have been outfitted with RFID or similar GPS-enabled tags, and engage in chat, voice, or other forms of communication in real-time with actual event participants and vendors. The participant at the actual event can have a hand-held device, heads up display (HUD) or other computing and/or communications device to complete the interaction. The map of the online convention space 50 will utilize GPS from real personnel at the actual event and then illustrate them on

In step 210, the online event host computing device 12 determines whether the gaming element, such as the avatar 58, from the registered one of the gaming computing devices 14(1)-14(n) has entered one of the vendor booths 54(1)-54(15) in the online event space 50, although the gaming element could enter other types of configured areas in the event space. While in the booth, the registered one of the gaming computing devices 14(1)-14(n) can communicate in real time with the registered one of the vendor booths 54(1)-54(15) for that selected booth as well as with other gaming elements currently in the booth, although the online event host computing device 12 is configured to provide live, real time communication between registered gaming computing devices 14(1)-14(n) and/or vendor computing devices 16(1)-16(n) anywhere in the event space 50 or in other locations. If in step 210 the online event host computing device 12 determines the gaming element from the registered one of the gaming computing devices 14(1)-14(n) has not entered one of the vendor booths 54(1)-54(15) or other configured area in the online event space 50, then the No branch is taken to step 212.

In step 212, the online event host computing device 12 determines whether the registered one of the gaming computing devices 14(1)-14(n) would like to exit. If in step 212 the online event host computing device 12 determines the registered one of the gaming computing devices 14(1)-14(n) would like to exit, then the Yes branch is taken to step 206 where this method ends. If in step 212 the online event host computing device 12 determines the registered one of the gaming computing devices 14(1)-14(n) would not like to exit, then the No branch is taken back again to step 208 described above.

If back in step 210 the online event host computing device 12 determines the gaming element from the registered one of the gaming computing devices 14(1)-14(n) has entered one of the vendor booths 54(1)-54(15) or another configured area in the online event space 50, then the Yes branch is taken to step 214. In step 214, the online event host computing device 12 can pan the gaming element, such as the avatar 58, around the event space 50 in response to commands from the registered one of the gaming computing devices 14(1)-14(n) to see the virtual objects 56(1)-56(4) and other elements and properties on display in the booth 54(1), although other numbers and types of objects or other elements as well as properties of the booth can be provided and displayed.

In step 216, the online event host computing device 12 determines whether the gaming element, such as the avatar 58, from the registered one of the gaming computing devices 14(1)-14(n) would like to interact with one of the objects 56(1)-56(4) in the vendor booth 54(1) which was entered in this example, although the gaming element could interact with other types and numbers of objects or other elements in the booth. A variety of different types of objects can be configured and operated by the online event host computing device 12 in the event space 50.

In one example, the online event host computing device 12 will be configured to provide three-dimensional sound map objects that will allow gaming elements from registered gaming computing devices 14(1)-14(n) to hover over various designated sound objects of the convention space 50 to click on an interactive button and listen in on real-time conversation and bustle from the same spot in the actual live event. These sounds maps may also provide a heat signature feature that will indicate to the registered gaming computing devices 14(1)-14(n) how much or how little audio activity is occurring at a given location by for example decibel level.

In another example, the online event host computing device 12 will be configured to allow video interaction objects to enable the presentation from the registered gaming computing devices 14(1)-14(n) on a large screen or Jumbotron device at the actual live show or event, allowing physical attendees to see what their virtual counterparts are doing.

In yet another example, the online event host computing device 12 will be configured to include the control objects to provide the ability for gaming elements of the registered gaming computing devices 14(1)-14(n) to control physical devices, such as a video camera by way of example only, at the actual live event. For example, one of the gaming elements of the registered gaming computing devices 14(1)-14(n) may be able to pan and zoom otherwise control a designated video camera at the actual corresponding live event.

If in step 216 the online event host computing device 12 determines the gaming element from the registered one of the gaming computing devices 14(1)-14(n) would not like to interact with one of the objects 56(1)-56(4) in the vendor booth 54(1), then the No branch is taken to step 218. In step 218, the online event host computing device 12 determines whether the gaming element for the registered one of the gaming computing devices 14(1)-14(n) would like to exit the current booth 54(1) in this example. If in step 218 the online event host computing device 12 determines the gaming element of the registered one of the gaming computing devices 14(1)-14(n) would like to exit the current booth 54(1), then the Yes branch is taken to step 212 as illustrated and described earlier. If in step 218 the online event host computing device 12 determines the gaming element for the registered one of the gaming computing devices 14(1)-14(n) would not like to exit the current booth 54(1), then the No branch is taken back again to step 216 described above

If in step 216, the online event host computing device 12 determines the gaming element from the registered one of the gaming computing devices 14(1)-14(n) would like to interact with one of the objects 56(1)-56(4) in the vendor booth 54(1), then the Yes branch is taken to step 220. In step 220, the online event host computing device 12 moves the gaming element, such as the avatar 58, around the event space 50 in response to commands from the registered one of the gaming computing devices 14(1)-14(n) close enough to interact with one or more of the virtual objects 56(1)-56(4) in the booth 54(1) in this example.

In step 222, the online event host computing device 12 provides a popup with an offer to start a live streaming video in the virtual object 56(4) to the registered one of the gaming computing devices 14(1)-14(n) which can be interacted, although other manners for offering content and other types of content can be offered. The online event host computing device 12 fades the popup from view on the virtual object after a first period of time, although the popup can be managed in other manners, such as by interacting with a tab to close the popup.

In step 224, the online event host computing device 12 determines in response to received commands from the gaming element whether the registered one of the gaming computing devices 14(1)-14(n) would like to start the live streaming video feed from the object 56(4) in the vendor booth 54(1) in this example, although the gaming element could interact with other types and numbers of objects or other elements in the booth to execute other operations. For example, the online event host computing device 12 can determine whether to start the interaction in response to a button being pressed on a game controller at the registered one of the gaming computing devices 14(1)-14(n), although other manners for receiving the command can be used. If in step 224 the online event host computing device 12 does not receive the command from the gaming element for the registered one of the gaming computing devices 14(1)-14(n) to start the live streaming video feed, then the No branch is taken back to step 218 as described earlier.

If in step 224 the online event host computing device 12 receives the command from the gaming element for the registered one of the gaming computing devices 14(1)-14(n) to start the live streaming video feed in virtual object 56(4) in this example, then the Yes branch is taken back to step 226. In step 226, the online event host computing device 12 starts providing the live streaming video feed with object 56(4) to the registered one of the gaming computer devices 14(1), although other types of content can be used which is produced in other manners. In an alternative example, the online event host computing device 12 could download the content at the virtual object to the registered one of the gaming computer devices 14(1).

If the selected virtual object requires user information, the information is automatically obtained by the online event host computing device 12 from the initial registration information, although other manners for obtaining the information can be used. The terms of use of this method may state that the online event host computing device 12 have the right to use and provide such registration information to one or more of the registered vendor computing devices 16(1)-16(n) automatically or when the registered one of the gaming computing devices 14(1)-14(n) enters their selected booth or interacts with an object in their booth. This registration information could also be used to quickly and easily sign up the registered gaming computing devices 14(1)-14(n) to receive follow communications, such as emails and other advertisements from one or more of the registered vendor computing devices 16(1)-16(n), such as those which were visited. In step 228, the online event host computing device 12 offers one or more additional command options to the gaming element of the registered one of the gaming computing devices 14(1)-14(n) to control the live streaming video feed from object 56(4), such as full screen, pause, play, rewind, fast forward, and stop by way of example only.

In step 230, the online event host computing device 12 determines whether the gaming element from the registered one of the gaming computing devices 14(1)-14(n) is done with the selected object 56(4) in the vendor booth 54(1). If in step 230, the online event host computing device 12 determines the gaming element from the registered one of the gaming computing devices 14(1)-14(n) is not done with the selected object 56(4), then the No branch is taken back to step 228. If in step 230, the online event host computing device 12 determines the gaming element from the registered one of the gaming computing devices 14(1)-14(n) is done with the selected object 56(4), then the Yes branch is taken back to step 216.

In another example, the online event host computing device 12 can implement a calendaring system to allow one or more of the registered vendor computing devices 16(1)-16(n) to offer an invitation to one or more of the registered one of the gaming computing devices 14(1)-14(n) to interact in a real time communication. This feature will support a real time communication between multiple registered gaming computing devices 14(1)-14(n) and/or registered vendor computing devices 14(1)-14(n) at a time per voice channel. This feature will be simple to use for registered gaming computing devices 14(1)-14(n), such as ones with XBox® Live's party up feature found in current multi-player online games. Additionally, the online event host computing device 12 can implement a survey process to enable one or more of the registered vendor computing devices 16(1)-16(n) to conduct surveys with one or more of the registered gaming computing devices 14(1)-14(n). Further, the online event host computing device 12 can monitor and track all activity by the registered gaming computing devices 14(1)-14(n), such as where each gaming element from one of the registered gaming computing devices 14(1)-14(n) walked, what booths were entered, and what virtual objects were interacted with by way of example only, and then provide this data to one or more of the registered vendor computing devices 16(1)-16(n) or other entities and/or award prizes for the most popular activity, such as the booth with the most traffic or the virtual object with the most activity.

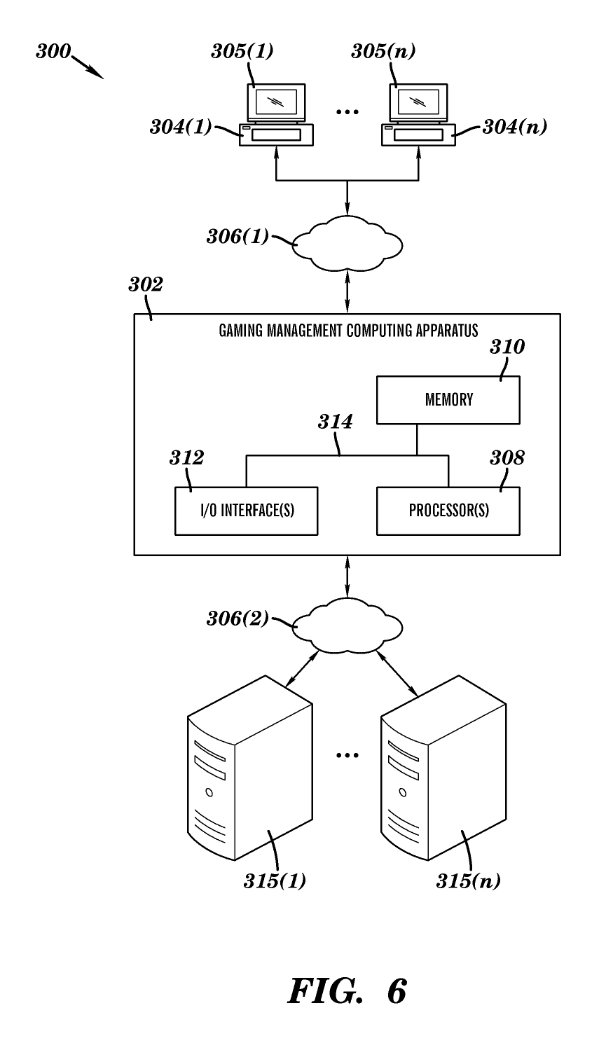

Another exemplary gaming environment 300 with a gaming management computing apparatus 302 is illustrated in FIG. 6. This exemplary gaming environment 300 includes a gaming management computing apparatus 302, gaming computing devices 304(1)-304(n), televisions 305(1)-305(n), and gaming site servers 315(1)-315(n) which are coupled together by one or more communication networks 306(1)-306(2), although other types and numbers of devices and components in other topologies could be used. While not shown, the environment 300 may include additional components.

More specifically, the one or more communication networks 306(1)-306(2), may comprise any wide area network (e.g., Internet), although any other type of communication network topology may be used. In this example, the gaming management computing apparatus 302 manages interactions between one or more of the gaming computing devices 304(1)-304(n), the televisions 305(1)-305(n), and the gaming site servers 315(1)-315(n), although gaming management computing apparatus 302 may perform other functions and one or more interactions could be executed by other devices.

The gaming management computing apparatus 302 includes processor(s) 308, memory 310, and interface(s) 312, which are coupled together by bus 314, although each may comprise other types and numbers of elements in other configurations. The processor(s) 308 execute instructions for the set up and interaction with the gaming computing devices 304(1)-304(n) and the televisions 305(1)-305(n) as well as other operations as illustrated and described herein. The processor(s) 308 may comprise one or more central processing units (“CPUs”) or general purpose processors with one or more processing cores, such as AMD® processor(s), although other types of processor(s) could be used (e.g., Intel®).

Memory 310 may comprise one or more tangible storage media such as, for example, RAM, ROM, flash memory, CD-ROM, floppy disk, hard disk drive(s), solid state memory, DVD, or any other memory storage type or devices, including combinations thereof, which are known to those of ordinary skill in the art. Memory 310 may store one or more computer-readable instructions that may be executed by the one or more processor(s) 308. When these stored instructions are executed, they may implement processes that are illustrated, for exemplary purposes only, by the flow chart diagrams illustrated and described herein. It should be appreciated the flow chart diagrams are representative of example steps or actions that may be embodied or expressed as one or more computer or machine readable instructions or other hardware logic that may be executed or otherwise controlled by the processor(s) 308 in gaming management computing apparatus 302 shown in FIG. 6. In this example, the non-transitory machine readable instructions may embody an algorithm or computer program for execution by at least one of: (a) one or more processors each having one or more processor cores, (b) hardware specifically configured to perform the instructions and (c) one or more other suitable processing device(s). The algorithm or computer program may be embodied in software stored on memory 310, for example. Input/output interfaces 312 include one or more interfaces and other physical and/or logical mechanisms for enabling gaming management computing apparatus 302 to communicate with the gaming computing devices 304(1)-304(n) and the televisions 305(1)-305(n) as well as other elements and devices.

Each of the gaming site servers 315(1)-315(n) includes a central processing unit (CPU) or processor, a memory, and an interface or I/O system which are coupled together by a bus or other link, although each could include other numbers and types of components or devices, such as a display device. In this example, gaming site servers 315(1)-315(n) each manage one or more online gaming accounts for one or more of the gaming computing devices 304(1)-304(n) which have registered and manage an inventory of one or more downloadable games, although the gaming site servers 315(1)-315(n) can provide and manage other types and numbers of functions.

Although an exemplary gaming environment 300 with the gaming management computing apparatus 302, the gaming computing devices 304(1)-304(n), the televisions 305(1)-305(n), and the gaming site servers 315(1)-315(n) are described and illustrated herein, other types and numbers of systems, devices, components, and elements in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any example. Accordingly, principles and advantages of distributed processing, such as redundancy and replication also can be implemented, as desired, to increase the robustness and performance of the devices and systems of the examples. The examples may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples also may be embodied as non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

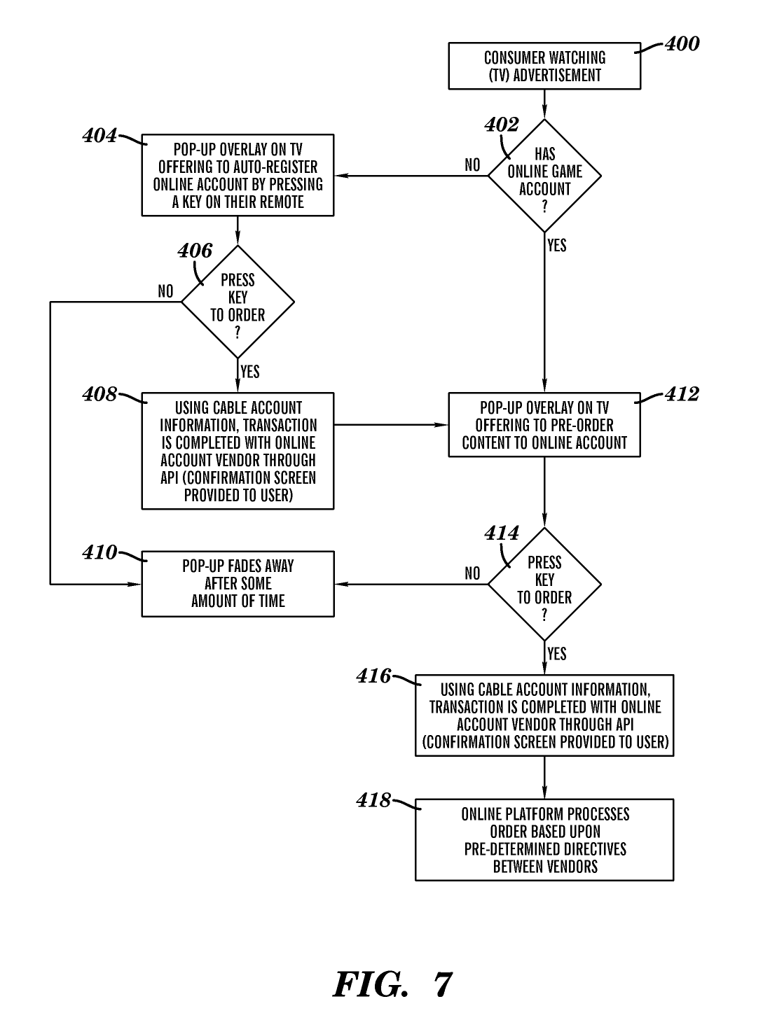

An exemplary method for providing content to a gaming account based on interaction with a television will now be described with reference to FIGS. 6-7, although other types of areas in the event space could be selected and configured by a vendor or other event demonstrator. Referring more specifically to FIG. 7, in step 400 one of the televisions 305(1)-305(n) associated with one of the gaming computing devices 304(1)-304(n) is turned on to view programming, including advertisements. The gaming computing device 304(1)-304(n) associated with the one of the televisions 305(1)-305(n) which is turned on may or may not be on at that time,

In step 402, the gaming management computing apparatus 302 determines whether the one of the gaming computing devices 304(1)-304(n) associated with the one of the televisions 305(1)-305(n) which is on has an online gaming account at one of the gaming site servers 315(1)-315(n), although the online gamin accounts could be at other locations, such as gaming management computing apparatus 302 by way of example only. If in step 402, the gaming management computing apparatus 302 determines the one of the gaming computing devices 304(1)-304(n) associated with the one of the televisions 305(1)-305(n) which is on does not have an online gaming account, then the No branch is taken to step 404.

In step 404, the gaming management computing apparatus 302 provides to the one of the televisions 305(1)-305(n) which is on an interactive pop-up overlay for display which offers to auto-register the associated one of the gaming computing devices 304(1)-304(n) to a gaming account if a button on the one of the televisions 305(1)-305(n) or an associated remote is pressed.

In step 406, the gaming management computing apparatus 302 determines whether the designated button was pressed to initiate the auto- registration process for the gaming account. If in step 406, the gaming management computing apparatus 302 determines the designated button was not pressed, then the No branch is taken to step 410 where the pop-up overlay fades away and this method ends. If in step 406, the gaming management computing apparatus 302 determines the designated button was pressed, then the Yes branch is taken to step 408.

In step 408, the gaming management computing apparatus 302 obtains the associated cable account information for the television from a third party cable provider server to completed the auto-registration and then proceeds to step 412, although other manners for registering can be used and other sources for obtaining the necessary registration information can be used. Additionally, in step 412 the gaming management computing apparatus 302 may request a final confirmation or completion of any missing registration information through another interactive pop-up overlay or other mechanism.

If back in step 402, the gaming management computing apparatus 302 determines the one of the gaming computing devices 304(1)-304(n) associated with the one of the televisions 305(1)-305(n) which is on has an online gaming account an online gaming account, then the Yes branch is taken to step 412.

In step 412 the gaming management computing apparatus 302 provides to the one of the televisions 305(1)-305(n) another interactive pop-up overlay offering to order and download content to the associated online gaming account if another button on the one of the televisions 305(1)-305(n) or an associated remote is pressed. Again the one of the gaming computing devices 304(1)-304(n) associated with the one of the televisions 305(1)-305(n) may be on or off. Additionally, by way of example only, the interactive pop-up message could offer the associated one of the gaming computing devices 304(1)-304(n) a download of a demo or other content to their associated gaming account or to order a ticket for an online event, such as an online convention or concert.

In step 414, the gaming management computing apparatus 302 determines whether the designated button was pressed to initiate the selection and download of the content to the associated online gaming account at one of the gaming site servers 315(1)-315(n). If in step 414, the gaming management computing apparatus 302 determines the designated button was not pressed, then the No branch is taken to step 414 where the pop-up overlay fades away and this method ends. If in step 414, the gaming management computing apparatus 302 determines the designated button was pressed, then the Yes branch is taken to step 416.

In step 416, if needed the gaming management computing apparatus 302 completes a financial transaction for downloading the content utilizing the registration information in the associated online gaming account, although other manners for completing the financial transaction if needed can be used. For example, the financial transaction might be an additional charge on upcoming cable bill associated with the cable account information or a charge to a credit card or online bank account associated for use in payment of the cable account. In step 418, the gaming management computing apparatus 302 processes and completes the download order of the selected game from one of the gaming site servers 315(1)-315(n) to either an associated gaming account for later retrieval or to the associated one of the gaming computing devices 304(1)-304(n) once the financial transaction is completed.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for providing content to a gaming account, the method comprising:
providing with a gaming management computing apparatus an interactive pop-up with an offer to download content for display during programming on a television associated with a gaming computing device;
determining with the gaming management computing apparatus whether an action with regard to the interactive pop-up was received indicating a selection of the offer; and
downloading with the gaming management computing apparatus the content to at least one of an online gaming account associated with the gaming computing device and the gaming computing device when the action indicating the selection was received.

2. The method as set forth in claim 1 further comprising:
determining with the gaming management computing apparatus whether the gaming computing device associated with the television which is displaying the programming has registered the online gaming account;
providing with the gaming management computing apparatus another interactive pop-up with an offer to automatically register the online gaming account;
determining with the gaming management computing apparatus whether an action with regard to the another interactive pop-up was received indicating a selection of the offer and
automatically registering with the gaming management computing apparatus the online gaming account for the gaming computing device associated with the television which is displaying the programming when the action indicating the selection was received.

3. The method as set forth in claim 2 wherein the automatically registering further comprises:
obtaining with the gaming management computing apparatus cable account information for the television which is displaying the programming and the another interactive pop-up overlay; and
automatically completing with the gaming management computing apparatus the registration of the online gaming account using the obtained cable account information.

4. The method as set forth in claim 1 further comprising:
obtaining with the gaming management computing apparatus cable account information for the television which is displaying the programming and the interactive pop-up overlay when the action indicating the selection was received; and
automatically completing with the gaming management computing apparatus a financial transaction for the content using the obtained cable account information before the downloading of the content to an online gaming account.

5. A computer readable medium having stored thereon instructions method for providing content to a gaming account comprising machine executable code which when executed by at least one processor, causes the processor to perform steps comprising:
providing an interactive pop-up with an offer to download content for display during programming on a television associated with a gaming computing device;
determining whether an action with regard to the interactive pop-up was received indicating a selection of the offer; and
downloading the content to at least one of an online gaming account associated with the gaming computing device and the gaming computing device when the action indicating the selection was received.

6. The medium as set forth in claim 5 further comprising:
determining whether the gaming computing device associated with the television which is displaying the programming has registered the online gaming account;
providing another interactive pop-up with an offer to automatically register the online gaming account;
determining whether an action with regard to the another interactive pop-up was received indicating a selection of the offer and
automatically registering the online gaming account for the gaming computing device associated with the television which is displaying the programming when the action indicating the selection was received.

7. The medium as set forth in claim 6 wherein the automatically registering further comprises:
obtaining cable account information for the television which is displaying the programming and the another interactive pop-up overlay; and
automatically completing the registration of the online gaming account using the obtained cable account information.

8. The method as set forth in claim 5 further comprising:
obtaining cable account information for the television which is displaying the programming and the interactive pop-up overlay when the action indicating the selection was received; and
automatically completing a financial transaction for the content using the obtained cable account information before the downloading of the content to an online gaming account.

9. A gaming management computing apparatus comprising:
one or more processors;
a memory coupled to the one or more processors by a bus, the one or more processors executing programmed instructions stored in the memory further comprising:
providing an interactive pop-up with an offer to download content for display during programming on a television associated with a gaming computing device;
determining whether an action with regard to the interactive pop-up was received indicating a selection of the offer; and
downloading the content to at least one of an online gaming account associated with the gaming computing device and the gaming computing device when the action indicating the selection was received.

10. The apparatus as set forth in claim 9 wherein the one or more processors further execute programmed instructions stored in the memory further comprising:
determining whether the gaming computing device associated with the television which is displaying the programming has registered the online gaming account;
providing another interactive pop-up with an offer to automatically register the online gaming account;
determining whether an action with regard to the another interactive pop-up was received indicating a selection of the offer and
automatically registering the online gaming account for the gaming computing device associated with the television which is displaying the programming when the action indicating the selection was received.

11. The apparatus as set forth in claim 10 wherein the one or more processors further execute programmed instructions stored in the memory for the automatically registering further comprising:
obtaining cable account information for the television which is displaying the programming and the another interactive pop-up overlay; and
automatically completing the registration of the online gaming account using the obtained cable account information.

12. The apparatus as set forth in claim 9 wherein the one or more processors further execute programmed instructions stored in the memory further comprising:
obtaining cable account information for the television which is displaying the programming and the interactive pop-up overlay when the action indicating the selection was received; and
automatically completing a financial transaction for the content using the obtained cable account information before the downloading of the content to an online gaming account.
